(19) United States
(12) Patent Application Publication
(10) Pub. No.: US 2006/0239780 A1
(43) Pub. Date: Oct. 26, 2006

(54) Manholes and inspection chambers

(76) Inventor: Chris Cawte, Belton (GB)

Correspondence Address: MCDERMOTT, WILL & EMERY (LOS ANGELES OFFICE), 2049 CENTURY PARK EAST, 34TH FLOOR, LOS ANGELES, CA, 90067-3208, US

(21) Appl. No.: 10/545,836

(22) PCT Filed: Feb. 18, 2004
(86) PCT No.: PCT/GB04/00636

§ 371 Date: Jan. 20, 2006

(30) Foreign Application Priority Data
Feb. 19, 2003 (GB) 0303777.7
Apr. 23, 2003 (GB) 0309169.1

(51) Int. Cl. F16L 55/18

(52) U.S. Cl. 405/184.1

(57) ABSTRACT

A manhole or inspection chamber, comprising at least one shaft section of first external diameter and a pot of smaller diameter adapted to be connected by a seal to the shaft member and to be connected to pre-existing pipes, whereby the seal permits relative vertical movement between the shaft section and pot.

This invention relates to manholes and inspection chambers. In particular, it relates to the base portions thereof

In underground drainage systems, it is important that access points be provided for inspection, clearage of blockages and maintenance. This access is generally provided by manholes or inspection chambers which are accessible from a roadway or other surface.

Traditionally, these have been constructed in situ of brick or concrete. More recently, in the UK, plastics have been used for small diameter shafts up to about 450 mm in diameter and shallow depths of less than about 1 m. Where man entry is required, the mininum shaft diameter is generally about 900 mm and it is usual to use precast concrete sections to form the sides of the chamber. These may be lined with a plastics material.

Presently, two methods are used for building manholes. In the first method, the so-called in situ method, the trench where the pipes are being laid is opened up to the full diameter of the manhole shaft and a concrete base is formed on site. Half pipes or channels are then laid on this and a precast concrete manhole ring is crudely cut to sit over the incoming pipes. A human operator then has to form benching by hand. Benching is sloped portion of the base which will ensure that water or other fluids are directed down into the channels before flowing into the pipes.

The drawbacks to this method are that it is time and labour consuming and requires a considerable amount of human labour which can take at least two days. Further, the in situ concrete base is generally of relatively poor quality, especially in situations of wet weather and/or high water table due to excessive water flow into concrete. Furthermore, a man has to enter a confined space to perform the benching and also the finished structure is rigid so that any settlement or movement creates cracks allowing egress of water or other fluid.

The second method presently used is to use a precast concrete manhole base. These, however, require the area where the pipes are laid to be more widely excavated and this is expensive. These precast concrete bases are also rigid in their design and require great care in their positioning and level in order to work properly. If used correctly, they can provide a water-tight structure but they are very heavy, require the use of a crane to install and a very wide initial hole to be dug.

More recently, the entry of a man into a confined space is now being discouraged and there is therefore an incentive to provide a system which allows for mass production of components suitable for man and non-man entry manholes and inspection chambers.

The present invention arose in an attempt to provide an improved manhole or inspection chamber.

According to the present invention there is a manhole or inspection chamber base, comprising at least one shaft section of first external diameter and a pot of smaller diameter adapted to be connected by a seal to the shaft member and to be connected to one or more pipes, whereby the seal permits relative vertical movement between the shaft section and pot.

In situ, a gap is most preferably formed between the top of the pipes and the bottom of the shaft section, where it over hangs the pot.

The shaft section preferably includes a tapered portion for tapering the internal diameter from a first broader diameter to a second diameter.

The joint between the shaft portion and the pot preferably permits vertical telescopic movement between the two to allow for settling or other affects. The joint is preferably an elastomeric seal.

Preferably, the pot is of minimum diameter sufficient to accommodate connection and/or change of direction of pipes entering and leaving the manhole.

The invention further provides a manhole or inspection chamber, comprising at least one shaft section having a load-bearing slab portion, and one or more pipes, wherein the slab portion lies above the top of the pipework

There is further provided a ground installation comprising a manhole or inspection chamber, comprising at least one shaft section of first external diameter and a pot of smaller diameter adapted to be connected by a seal to the shaft member and to be connected to one or more pipes, whereby the seal permits relative vertical movement between the shaft section and pot.

Embodiments of the invention will now be described, by way of example only, with reference to the accompanying drawings, in which:

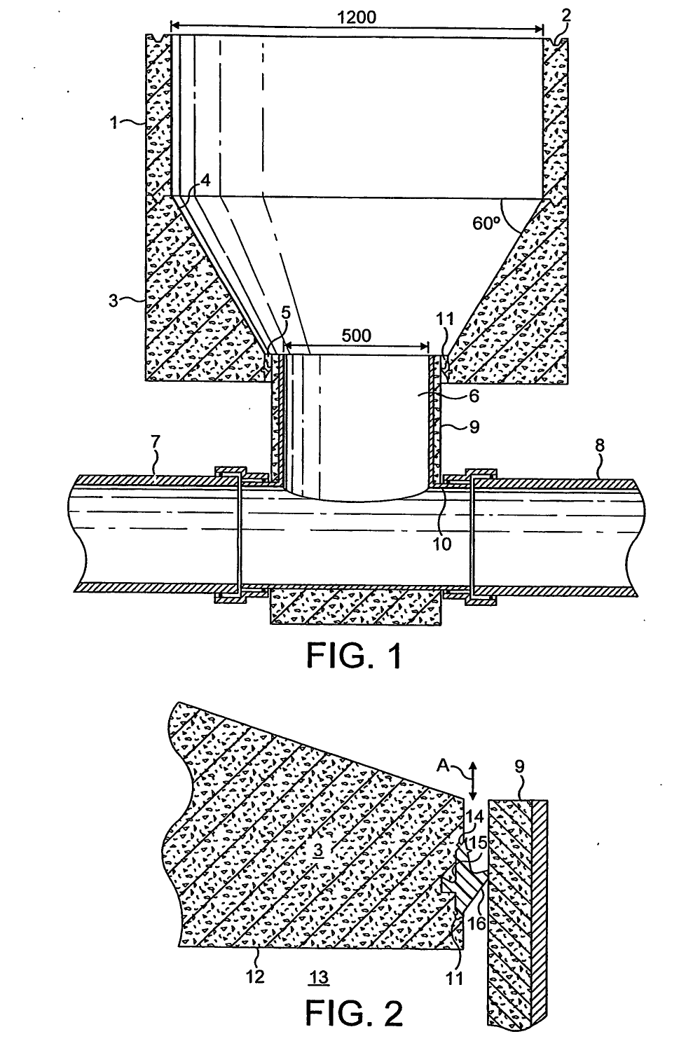

FIG. 1 shows a cross section through a manhole base;

FIG. 2 shows a detail of a joint between a manhole base and a central pot;

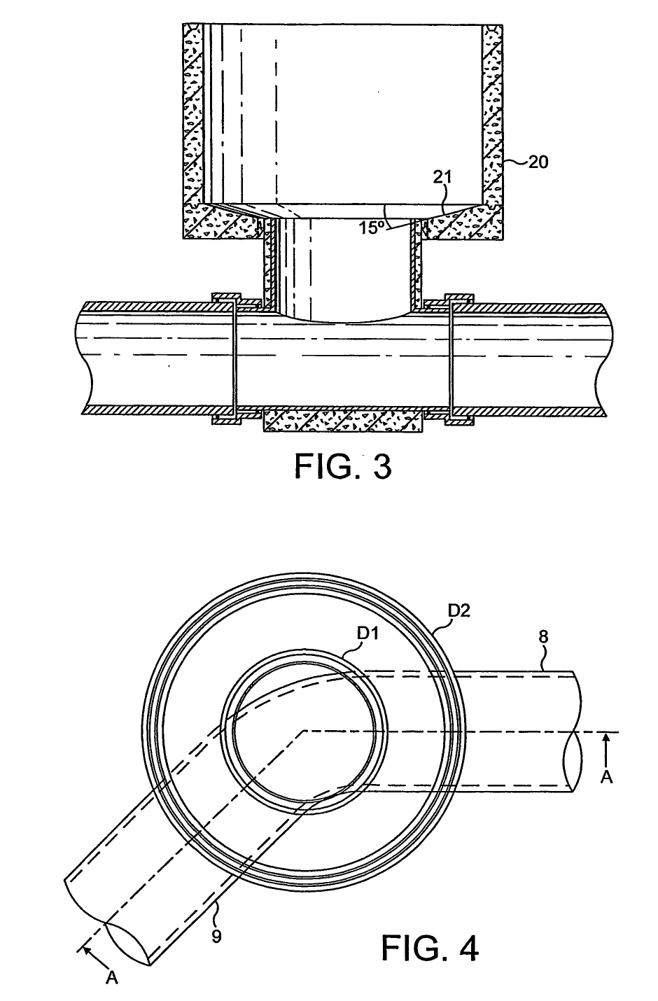

FIG. 3 shows a cross section through an alternative manhole base;

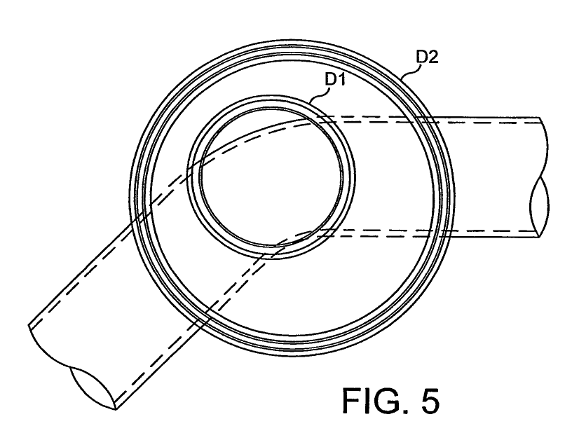

FIG. 4 shows a plan view; and

FIG. 5 shows a plan view of an alternative construction.

Referring to FIG. 1, a manhole base according to the present invention comprise sat least one manhole ring 1 of generally constant internal and external diameter, and preferably a stack of rings, stacked one on top of the other to form the body of the manhole. In the example shown, this is of internal diameter 1200 mm.

The manhole rings attach to each other by means of cooperating circumferential tongue and groove connections as shown 2. Attached to the bottom manhole ring is a base part 3 of constant external diameter 1200 mm but of tapering internal diameter which is greater at its top 4 and than its bottom 5. As shown, the manhole ring and base part are of concrete material, although they may be lined with a plastics materials if necessary. An aperture 6 is formed at the bottom of the base component 3 of diameter a little over 500 mm. The bottom of part 3 is spaced above pre-existing pipes 7 and 8. An additional ‘pot’ 9 forms the manhole base itself and is of minimum diameter to fit within aperture 5.

The pot 9 has a radially extending portion 10 at its bottom which is adapted to connect with pre-existing pipework 7, 8 in conventional manner.

Between the outside of pot 9, and the aperture 6 within shaft piece 3, is a radial seal 11, a non-limiting example of which is shown in more detail in FIG. 2. As shown in this figure, the base part 12 of shaft member 3 lies directly upon unexcavated ground 13. The cylindrical top section of pot 9 lies within an aperture formed in the base of shaft 12 and is connected to it by seal 11. This will typically be an elastomeric seal, preferably of rubber or alternative of a plastics material. The exact configuration of seal 11 may vary but essentially it comprises a portion 14 which locates into a corresponding receiving portion 15 of shaft 3 and which is of relatively large extent. A protrusion 16 which is generally tapering extends from part 14 away from shaft 3 and it is the end of this part 16 that pot 9 presses against. It is seen that this allows for relative vertical movement, ie telescopic type movement, between shaft 3 and pot 9, as indicated by double headed arrow A.

In effect, there is a vertical joint at the bottom of the shaft.

The advantages of the invention are many. First, by allowing for a degree of vertical relative movement between the shaft portion 3 and the pot movement of the ground, or subsidence, at the pipe level is easily accommodated, without causing potentially dangerous movements in the entire shaft structure, as would have been the case with previous systems. The much lighter and smaller pot is the only part that would be moved. Second, the shaft and slab members sit upon unexcavated ground 13 which would have previously have required to be excavated for the base. This means that at the level where the pipes are laid, ground only needs to be excavated slightly wider than the trench for the pipes, in order to accommodate the cylindrical width (eg 500 mm) of the pot, rather than being excavated to the fill width of the manhole itself, 1200 mm in this case. The slab can sit upon unexcavated ground and the seal accommodates relative movement, eg ground shifting, so additional sealing or packing materials are not necessary.

Furthermore, the pot itself can be of standard diameter, eg 500 mm, and can. accommodate slabs of different diameters and angles based on the size of the manhole shaft and whether it is for man or non-man entry. FIG. 3 shows an example of a different diameter shaft, in this case the shaft 20 is of diameter 1500 mm. The benching, or sloping portion 21 of this is of a much smaller angle, 15° than the angle of the system shown in FIG. 1 and this is intended for a man to be able to enter the manhole and to be able to stand upon the benching.

FIG. 4 shows how the diameter of hole excavated at the level where the pipes are laid need only be the width of, or slightly larger than the trench for the pipes, to accommodate the pot. With prior art arrangements, the entire diameter D2 would have had to be excavated all the way down to the pipe level.

The arrangement of the invention enables the pot to be easily positioned other than coaxially with the shaft. FIG. 5 shows an embodiment in which the pot (D₁) is clearly eccentric relative to the shaft (D₂). This enables a larger standing area to one side of the pot. Furthermore, the shaft can then have easier adjustment.

Amongst other advantages, the spacing between the bottom of the load-bearing slab 12 and the top of the pipes, and/or vertical joint in embodiments of the invention, above the pipelines, permits relative movement between shaft and pipes.

The reduced diameter of the pot enables a considerably reduced excavation at pipe level, which also results in better bedding conditions for the shaft.

Furthermore, the modular construction enables great flexibility, and variation, in pipe sizes, angles and connections, shaft diameter and the choice of man- or non man access.

The manhole may be installed at the same time as new pipework or installed later, ie renovation.

1. A manhole or inspection chamber, comprising a shaft having a load-bearing slab portion, the slab portion being configured to lie above one or more pipes and being spaced therefrom by substantially unexcavated ground.

2. A ground installation, comprising a manhole or inspection chamber, having a shaft with an external diameter and a pot with a diameter smaller than the external diameter of the shaft, the pot being connected by a seal to the shaft and connected to one or more pipes, whereby the seal permits relative vertical movement between the shaft and pot.

3. A ground immolation comprising a manhole or inspection chamber having a load-bearing slab and one or more pipes, wherein the slab lies above one or more pipes and is spaced therefrom by unexcavated ground.

4. A manhole or inspection chamber base, comprising a shaft having an external diameter and a pot having a diameter smaller than the external diameter of the shaft, the pot being adapted to be connected by a seal to the shaft and to be connected to one or more pipes, whereby the seal permits relative vertical movement between the shaft and the pot, the configuration being such that the bottom of the shaft lies, in use, spaced above the one or more pipes.

5. The manhole or inspection chamber base of claim wherein a gap is formed between the top of the one or more pipes and the bottom of the shaft, which extends beyond the pot.

6. The manhole or inspection chamber base of claim 4 wherein at least a portion of the inside diameter of the shaft is tapered from a first to a second diameter.

7. The manhole or inspection chamber base of claim 4 wherein the joint at the seal permits relative vertical telescopic movement between the shaft and the pot.

8. The manhole or inspection chamber base of claim 4 wherein the seal is an elastomeric seal.

9. The manhole or inspection chamber base of claim 4 wherein the pot is coaxial with the shaft.

10. The manhole or inspection chamber base of claim 4 wherein the pot axis is eccentric relative to the shaft axis.

11. The manhole or inspection chamber base of claim 10 wherein the eccentricity of the not relative to the shaft enables an internal platform to be formed, for supporting a person inside the shaft.

12. The manhole or inspection chamber base of claim 10 wherein the shaft includes a load-bearing slab which lies above, and spaced from, the top of the one or more pipes, and is separated therefrom by unexcavated ground.

13. (canceled)

14. A method of installing a manhole or inspection chamber having a shaft with a load-bearing slab, the method comprising:
positioning the load-bearing slab on substantially unexcavated ground above one or more in-situ pipes.

15. A method of installing a manhole or inspection chamber having a shaft with an external diameter and a pot with a diameter smaller than the external diameter of the pot, the method comprising:
connecting the pot to one or more in-situ pipes; and
using a seal to connect the pot to the shaft, the seal permitting relative movement between the shaft and the pot.

16. The method of claim 15 further comprising positioning the shaft on substantially unexcavated ground above the one or more pipes.

17. The method of claim 16 wherein at least a portion of the inside diameter of the shaft is tapered from a first diameter to a second diameter.

18. The method of claim 16 wherein the seal permits relative telescopic movement between the shaft and the pot.

19. The method of claim 16 wherein the seal is an elastomeric seal.

20. The method of claim 16 wherein the pot is coaxially connected with the shaft.

21. The method of claim 16 wherein the pot is connected to the shaft with the pot axis being eccentric to the shaft axis.

22. The method of claim 21 further comprising forming an internal platform to support a person in the shaft.

23. The method of claim 16 wherein the shaft comprises a load-bearing slab, the method further comprising position the load-bearing slab on substantially unexcavated ground above the one or more pipes.
